(19) United States
(12) Patent Application Publication
(10) Pub. No.: US 2024/0041232 A1
(43) Pub. Date: Feb. 8, 2024

(54) PILLOW SOUND SYSTEM

(71) Applicant: Headwaters, Inc., Marblehead, MA (US)

(72) Inventors: Troy Anderson, Marblehead, MA (US); Alin Zanfirescu, Sag (RO); Stephanie Anderson, Marblehead, MA (US)

(21) Appl. No.: 17/878,951

(22) Filed: Aug. 2, 2022

(51) Int. Cl. A47G 9/10; H04R 5/02; H04R 1/02

(52) U.S. Cl. CPC A47G 9/1009; A47G 9/1045; H04R 5/023; H04R 1/028; A47G 2009/006

(57) ABSTRACT

A pillow sound system keeps pillow speakers in place under a pillow, allows to adjust the distance between the pillow speakers to accommodate different head/neck sizes and/or head sizes, stows any excess stereo speaker interconnection cord and is comfortable and unobtrusive in use.

### FIELD OF THE INVENTION

This invention relates in general to pillows and to stereophonic speaker systems, and more particularly, to a novel pillow sound system.

### BACKGROUND OF THE INVENTION

Pillow speakers are placed under pillows to help the user fall asleep, obtain higher quality sleep or to enjoy audio from various devices such as a TV, music player, smart phone, tablet, etc. Many pillow speakers, such as the commercially available Sound Oasis® model SP-101, provide freestanding speaker units intended for insertion inside, under or round about existing pillows. But these freely standing units are not secured in the pillows, so the speakers themselves move around during use, causing varying sound quality for the user, since the speakers can flip over (and the sound output is muffled), or the speakers can move out of the proper location for optimal hearing quality (i.e. the optimal hearing location typically is close to each ear of the user), or may be perceived as uncomfortable. Other pillow speakers do hold the pillow speakers in place, such as the commercially available Pillowsonic™ pillow speaker, but do not allow the user to adjust the width between the pillow speakers therewithin to suit their particular head/body size or preference, and/or head dimensions (and thus the distance from ear to ear), which vary from person to person, depending on age, gender, body sizes and other factors. There are also pillows provided with built-in speaker receiving pockets, in which speakers are received, such as the Sound Pillow of U.S. Pat. No. 7,627,917, incorporated herein by reference. However such systems are not so compact as to be readily fit in a suitcase and typically are used in place of the user's already owned pillows.

There is thus the need for a pillow sound system having all the advantages of the heretofore known systems but with none of their attendant disadvantages.

### SUMMARY OF THE INVENTION

Accordingly, it is one object of the present invention to disclose a pillow sound system usable with any pre-existing pillow or head rest.

Another object of the present invention is to disclose a pillow sound system that can accommodate different head sizes and/or head/body sizes.

Another object of the present invention is to disclose a pillow sound system that is not subject to the potentially undesirable effects of unintended speaker movement.

A further object of the present invention is to disclose a pillow sound system that is comfortable and unobtrusive in use.

Yet another object of the present invention is to disclose a pillow sound system that is manufacturable at comparatively low-cost.

A further object of the present invention is to disclose a pillow sound system that is readily portable.

A further object of the present invention is to disclose a pillow sound system that is easy to adjust.

In accord with these and other objects, the pillow sound system of the present invention discloses first and second longitudinally extending arms each having outer and inner ends; speaker attaching members are disclosed at the outer ends of each of the first and second arms that hold speakers attached thereby in place against dislodgment; and first and second interconnection members are disclosed at the inner ends of the first and second arms that cooperate to attach said first and second arms together in such a way that the longitudinal extension defined between the outer ends of the arms, and therewith the longitudinal width defined between the speaker attaching members, is selectively adjustable between comparatively-longer and comparatively-shorter maximum and minimum values.

The first and second longitudinally extending arms having outer and inner ends are preferably formed of a flexible and comfortable substrate material such as rubber rendering the arms substantially physically unobtrusive, which mitigates if not eliminates sleep and/or rest or music enjoyment disruption.

The speaker attaching members that hold the speakers in place on the first and second arms preferably are walls integrally formed with the flexible and comfortable substrate material of the arms providing speaker receiving cavities that removably receive speakers and hold them in place therewithin against rotation and unintended dislocation.

The first and second interconnection members preferably are first and second arrays of longitudinally and transversely spaced apart male and female elements proximate the inner ends of respective ones of said first and second arms that are cooperative to adjustably attach the first and second arms together by simple and easy insertion and removal of the male elements into and out of any selected female elements.

Stereo speakers typically are connected by an electrical wire. Speaker wire take-up members are disclosed proximate the walls providing speaker receiving cavities to take up any excess speaker wire which help to prevent unmanaged cord from disrupting sleep and/or rest or music enjoyment.

### BRIEF DESCRIPTION OF THE DRAWINGS

Other objects, advantageous features, and inventive aspects of the present invention will become apparent as the invention becomes better understood by referring to the following, solely exemplary, detailed description of the presently preferred embodiments thereof, and to the drawings, wherein:

FIG. 1 is a block diagram of the pillow sound system of the present invention;

FIG. 2 is an exploded bottom perspective view of one presently preferred embodiment of the pillow sound system in accord with the present invention;

FIG. 3A is a top plan view and FIG. 3B is a bottom plan view of the pillow sound system in accord with the present invention with arms unattached; and

FIG. 4A is a side view of the pillow sound system in accord with the present invention with arms attached in their condition of maximum extension and FIG. 4B is a side view of the pillow sound system in accord with the present invention with arms attached in their condition of minimum extension.

### DETAILED DESCRIPTION OF THE PRESENTLY PREFERRED EMBODIMENTS

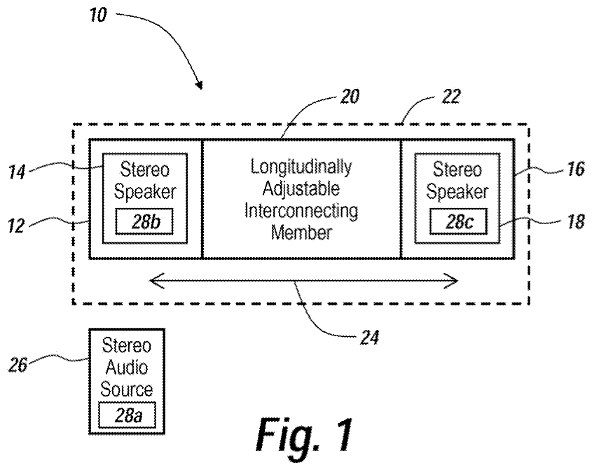

Referring now to FIG. 1, generally designated 10 is a block diagram of the pillow sound system of the present invention. The system 10 includes a first arm schematically illustrated by box 12, adapted to attach a stereo speaker 14 and securely hold it in place against unintended motion on the arm 12, a second arm illustrated by box 16, adapted to attach a stereo or other speaker 18 thereto and securely hold it in place against unintended motion on the arm 16, and a longitudinally adjustable member 20 interconnecting the arms 12, 16. The arms 12, 16 and/or interconnecting member 20 may be separate units or different cooperative parts of a single member without departing from the inventive concepts.

A dashed box 22 illustrates an user's pillow, which may be the pillow the user typically uses or another headrest without requiring a special purpose pillow.

As illustrated schematically by arrow 24, the longitudinal extension of the arms 12, 16, and therewith the width between the stereo speakers 14, 18, is selected by controllably adjusting the longitudinally adjustable member 22 to provide that longitudinal width that accommodates the different head/body sizes and/or head sizes of each particular use situation. Any suitable longitudinally adjustable interconnecting member to provide longitudinal adjustment of the width defined between the stereo speakers 14, 18 that is variable to accommodate different head/body sizes and/or head sizes may be employed without departing from the inventive concepts.

A stereo audio source, such as CD player, iPod, iPhone and the like, is schematically illustrated by box 26. An audio interconnection, schematically illustrated by boxes 28a, 28b, 28c, supplies the audio provided by the stereo audio source 26 to the stereo speakers 14, 18. The audio interconnection 28a, 28b, 28c may be any suitable audio interconnection for providing audio to the stereo speakers, either wired or wireless, without departing from the inventive concepts.

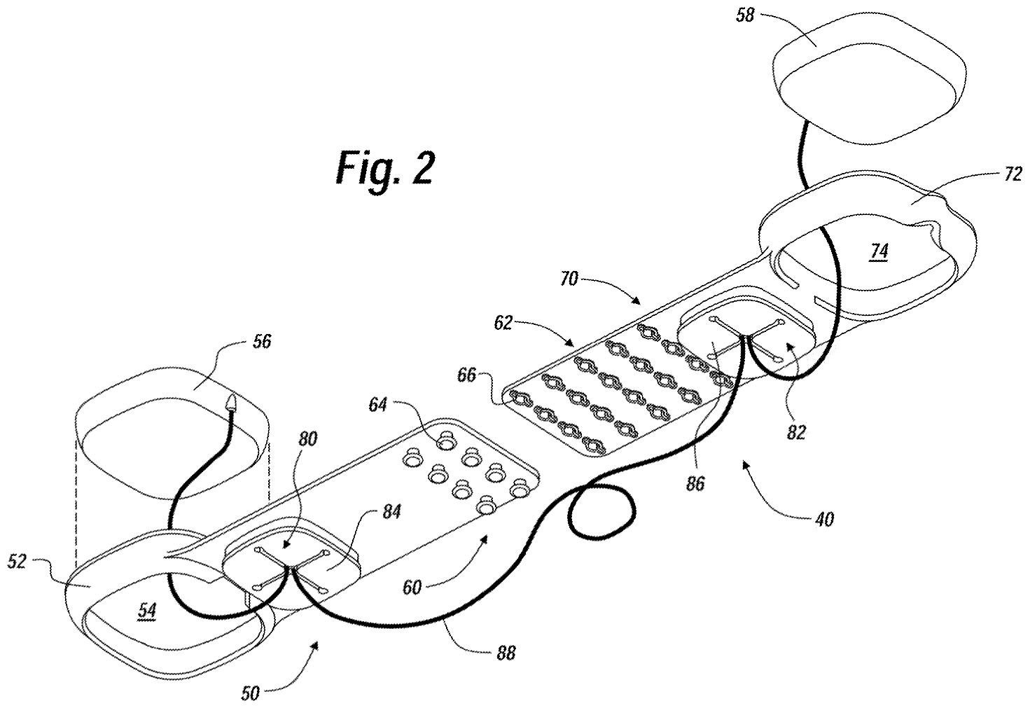

Referring now to FIG. 2, generally designated 40 is an exploded bottom perspective view of one presently preferred embodiment of the pillow sound system in accord with the present invention. The system 40 includes first and second arms generally designated 50, 70 each having inner and outer ends. Walls 52, defining a speaker receiving recess generally designated 54, are carried at the outer end of the first arm 50. Walls 72, defining a speaker receiving recess generally designated 74, are carried at the outer end of the second arm 70.

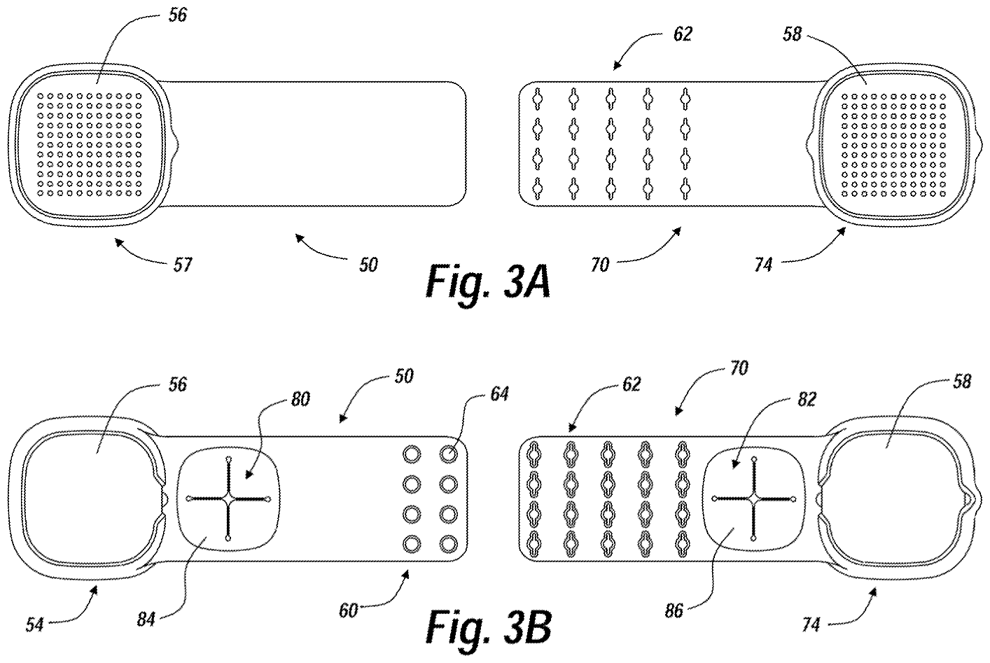

As best seen in FIG. 2 and FIGS. 3A, 3B, left and right stereo speakers 56, 58 are received in the recesses 54, 74 provided therefor on the outer ends of the arms 50, 70.

First and second arrays generally designated 60, 62 are respectively provided on the inner ends of the first and second arms 50, 70.

The first array 60 includes longitudinally and transversely spaced apart male elements 64 provided on the inner end of the arm 50. The second array 62 includes longitudinally and transversely spaced apart female elements 66 provided on the inner end of the second arm 70. The male elements 64 of the array 60 may be received in the female elements 66 provided therefor on the second array 62. In this way, as appears more fully hereinbelow, the longitudinal extension of the interconnected arms, and therewith the width between the speakers 56, 58, is readily and selectively adjustable between maximum and minimum values to accommodate any head size and/or head/neck size, or pillow size or other preference.

A different number, shape and/or arrangement of the elements of at least one male and of at least one female element other than the two-by-four (2×4) and five-by-four (5×4) arrays of male and female elements 60, 62 of the presently preferred embodiment may be employed without departing from the inventive concepts. Although the longitudinal adjustment of width is preferably provided by the insert, hold and withdraw cooperation provided by the male and female elements 60, 62 that is easy for any age of hand/fingers to use, different width adjustment mechanisms like adjustable fasteners could be employed without departing from the inventive concepts.

As seen in FIG. 2, an electrical wire connection 88 electrically connects the stereo speakers 56, 58.

As best seen in FIG. 2 and FIG. 3B, walls generally designated 80, 82 defining electrical wire receiving reservoirs having flexible lips 84, 86 that flex open to receive the wire 88 and flex closed to retain wire therewithin are respectively provided intermediate the inner and outer ends of the arms 50, 70.

For any selected longitudinally-adjusted width, any excess speaker interconnection cord is pushed past the flexible lips 84, 86 and into the cord receiving reservoirs 80, 82. The flexible lips flex back to confine the excess cord within the reservoirs provided therefor, which helps to prevent unmanaged cord from disrupting sleep and/or rest or music enjoyment.

A different number and configuration of excess cord take up and release members could be employed without departing from the inventive concepts.

The arms 50, 70, and together therewith, the elements 52-54, 60-66, 72, 74, preferably are integrally formed of rubber or another soft pliable substrate material.

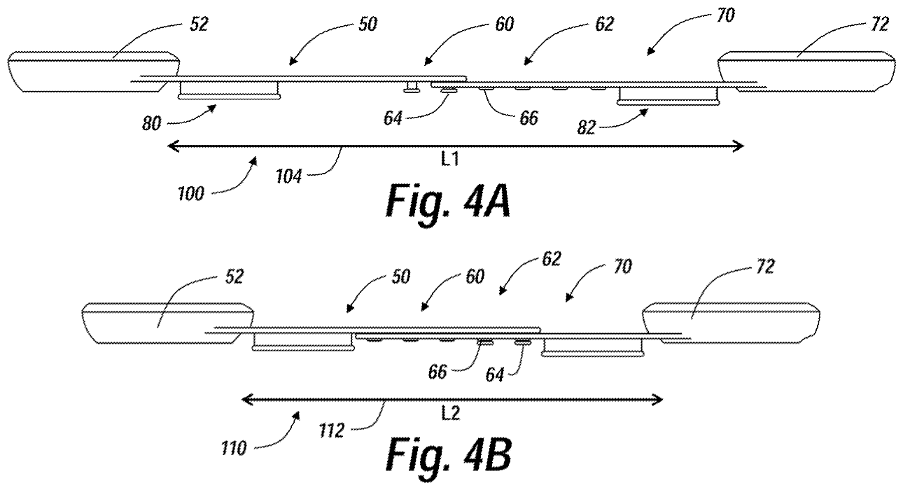

Referring now to FIGS. 4A, 4B, generally designated at 100 is a side view and generally designated at 110 is a side view respectively illustrating the pillow sound system in its conditions of maximum and minimum longitudinal extension in accord with the present invention.

As shown in FIG. 4A, the male elements 64 of the longitudinally and transversely extending array 60 carried at the innermost end of the arm 50 are received in corresponding female elements 66 of the longitudinally and transversely extending array 62 carried by the innermost end of the arm 70, thereby interconnecting the arms 50, 70 in their condition of maximum extension schematically illustrated by arrow 104 marked “L1” The distance L1 is preferably eight-and-six-tens (8.6) inches.

As shown in FIG. 4B, the male elements 64 of the longitudinally and transversely extending array 60 carried at the innermost end of the arm 50 are received in corresponding female elements 66 of the longitudinally and transversely extending array 62 defined at the outermost end of the array 62 on the arm 70, thereby interconnecting the arms 50, 70 in their condition of minimum extension schematically illustrated by arrow 112 marked “L2.” The distance L2 is preferably six-and-two-tenths (6.2) inches.

Different values for the lengths L1 and L2 could, of course, be employed without departing from the inventive concepts.

As seen in FIGS. 4A, 4B, the interconnected arms 50, 70 in overlapping relation are such that the arm 50 is above the arm 70 by a distance that corresponds to the thickness of the arm 50. To keep the tops of the speakers 56, 58 in the same horizontal plane, the arm 70 is attached to the walls 72 at a vertical distance that is greater that the vertical distance that the arm 50 is attached to the speaker walls 52 by a magnitude that corresponds to the thickness of the arm 50.

Many modifications of the present invention will become apparent to those of skill in the art having benefitted from the instant disclosure without departing from the inventive concepts.

What is claimed is:

1. A pillow sound system, comprising:
first and second longitudinally extending arms each having an outer and an inner end;
speaker attaching members respectively at the outer ends of each of the first and second arms that hold the speakers attached thereby in place against dislodgment and unintentional dislocation; and
first and second interconnection members respectively at the inner ends of the first and second arms that cooperate to attach said first and second arms together in such a way that the longitudinal extension defined between the outer ends of the arms, and therewith the longitudinal width defined between the speaker attaching members, is selectively adjustable between comparatively-longer and comparatively-shorter maximum and minimum values.

2. The pillow sound system of claim 1, wherein said arms are formed of a flexible and comfortable substrate material.

3. The pillow sound system of claim 2, wherein said material is rubber.

4. The pillow sound system of claim 1, wherein said speaker attaching members at the outer ends of the first and second arms that hold the speakers attached thereby in place against dislodgment are walls defining speaker receiving cavities.

5. The pillow sound system of claim 2, wherein said speaker attaching members at the outer ends of the first and second arms that hold the speakers attached thereby in place against dislodgment are walls defining speaker receiving cavities integrally formed with the substrate of the arms.

6. The pillow sound system of claim 1, further including first and second stereo speakers.

7. The pillow sound system of claim 1, wherein the first interconnection member includes a first array of longitudinally and transversely spaced apart male elements proximate the inner end of one of said arms and the second interconnection member includes a second array of longitudinally and transversely spaced apart female elements proximate the inner end of the other of said first and second arms adapted to receive said male elements of said first array, the first and second arrays are cooperative to releasably attach the first and second arms together so that the longitudinal extent between the outer ends of the arms is adjustable between comparatively-longer and comparatively-shorter maximum and minimal values in dependence on which of the female elements of the second array of elements is selected to receive the male elements of the first array of male elements, whereby different head/body sizes and/or head sizes may be accommodated.

8. The pillow sound system of claim 7, wherein said arms are formed of a flexible substrate material, and wherein said first array is integrally formed with the substrate material of said first arm.

9. The pillow sound system of claim 7, wherein said arms are formed of a flexible substrate material, and wherein said second array is integrally formed with the substrate material of said second arm.

10. The pillow sound system of claim 6, wherein said stereo speakers are connected by an electrical wire, and further including at least one speaker wire receiving member provided on at least one arm to take up any excess speaker wire.

11. The pillow sound system of claim 10, wherein said arms are formed of a flexible and comfortable substrate material and wherein said at least one speaker wire receiving member provided on said at least one arm to take up any excess speaker wire is integrally formed with said substrate of said at least one arm.

12. The pillow sound system of claim 11, wherein said at least one speaker wire receiving member includes an excess cord receiving reservoir having flexible lips.

13. A pillow sound system, comprising:
first and second speakers electrically interconnected by an electrical cord that extends therebetween;
a longitudinally extending support member adapted for insertion into a pillow that supports said first and second speakers at a longitudinally spaced apart width; and
an element carried by said support member adapted to take up cord that exceeds said longitudinally spaced apart width.

14. The pillow sound system of claim 13, wherein said element is an excess cord receiving reservoir.

15. The pillow sound system of claim 13, wherein said support member includes a width adjustment member to selectively vary said width.

16. The pillow sound system of claim 13, wherein said longitudinally extending support member adapted for insertion into a pillow that supports said first and second speakers at a longitudinally spaced apart width retains and secures the same against unintended dislocation.

17. A sound pillow system that accommodates different head sizes and/or head/neck sizes, comprising:
a pillow insertable longitudinally extended speaker receiving member that supports first and second stereo speaker mounting members spaced apart along said longitudinally extended speaker receiving member and that includes a width adjustable member intermediate said spaced apart first and second stereo speaker mounting members such that by adjusting the width of the width adjustable member the spacing between said spaced apart first and second stereo speaker mounting members is controllably adjusted to accommodate said different head sizes and/or head/neck sizes.

18. The sound pillow system that accommodates different head sizes and/or head/neck sizes of claim 17, wherein first and second arms are cooperative to provide said longitudinally extended speaker mounting member.

19. The sound pillow system that accommodates different head sizes and/or head/neck sizes of claim 18, wherein first and second arrays of male and female elements respectively provided on said first and second arms are cooperative to provide said width adjustable member.

20. The sound pillow system that accommodates different head sizes and/or head/neck sizes of claim 17, further including first and second stereo speakers.
